(19) United States
(12) Patent Application Publication
(10) Pub. No.: US 2011/0072469 A1
(43) Pub. Date: Mar. 24, 2011

(54) Addressing Fringe Areas in Broadcast Networks

(75) Inventors: Jani Väre, Kaarina (FI); Jyrki Alamaunu, Turku (FI)

(73) Assignee: Nokia Corporation, Espoo (FI)

(21) Appl. No.: 12/562,594

(22) Filed: Sep. 18, 2009

(51) Int. Cl. H04N 7/16; H04W 36/00

(52) U.S. Cl. 725/62; 455/436; 455/443

(57) ABSTRACT

Methods and systems for addressing fringe areas within a broadcast network are described. At least one broadcast stream may be transmitted at a broadcast network A determination may be made as to whether a fringe area exists in the broadcast network. Information of the fringe area may be provided to a receiver in at least one signaling section associated to the at least one broadcast stream. A fringe area may occur within a single transmitter coverage area or cell of the broadcast network or over a plurality of different transmitter coverage areas or cells within the broadcast network. The fringe areas may be represented by one or more generally elliptically shaped regions.

### BACKGROUND

In mobile broadcast networks, such as next generation digital video broadcast network, a fringe area within a cell or spanning across multiple cells influence the quality of service to end users. When fringe areas, such as tunnels, indoor areas, secluded areas, etc., occur within a broadcast network, a receiver has no means to detect such fringe areas before entering one or being very close to the fringe areas. Hence, such a receiver does not attempt to choose another broadcast network.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the present disclosure relate to a system and method for signaling and determining one or more fringe areas within broadcast networks. Other aspects provide methods which utilize ellipses in signaling the fringe areas within a broadcast network to one or more receivers.

### BRIEF DESCRIPTION OF THE DRAWINGS

Certain embodiments are illustrated by way of example and not limited in the accompanying figures in which like reference numerals indicate similar elements and in which:

FIG. 1 is a block diagram of an example content distribution network in which one or more embodiments may be implemented.

FIG. 2 is a block diagram of an example communication/receiving device according to one or more aspects described herein.

FIG. 3 illustrates an example DVB-T2/NGH broadcast network in which tunneled streams may be carried in a carrier stream according to one or more aspects described herein.

FIG. 4A illustrates an example broadcast stream according to one or more aspects described herein.

FIG. 4B illustrates example L1 pre- and post-signaling sections and syntaxes thereof according to one or more aspects described herein.

FIG. 5 illustrates an example diagram of a cell with several transmitter coverage areas according to one or more aspects described herein.

FIG. 6 illustrates an example diagram of a network with several cells according to one or more aspects described herein.

FIG. 7 illustrates the example diagram of a cell in FIG. 5 with a fringe area included according to one or more aspects described herein.

FIG. 8 illustrates the example diagram of a network in FIG. 6 with a fringe area included according to one or more aspects described herein.

FIG. 9 illustrates a diagram of signaling of a fringe area by utilizing an ellipse according to one or more aspects described herein.

FIGS. 10A-10D illustrate examples of different shaped fringe areas indicated by an ellipse according to one or more aspects described herein.

FIG. 11 illustrates an example of a fringe area indicated by a plurality of ellipses according to one or more aspects described herein.

FIGS. 12A-12D illustrate examples of a fringe area signaling structure according to one or more aspects described herein.

FIG. 13 is a flowchart illustrating an exemplary method for fringe area handover according to one or more aspects described herein.

FIG. 14 is a flowchart illustrating an exemplary method for fringe area broadcast according to one or more aspects described herein.

### DETAILED DESCRIPTION

In the following description of the various embodiments, reference is made to the accompanying drawings, which form a part hereof, and in which are shown by way of illustration various embodiments in which the invention may be practiced. It is to be understood that other embodiments may be utilized and structural and functional modifications may be made without departing from the scope of the present invention.

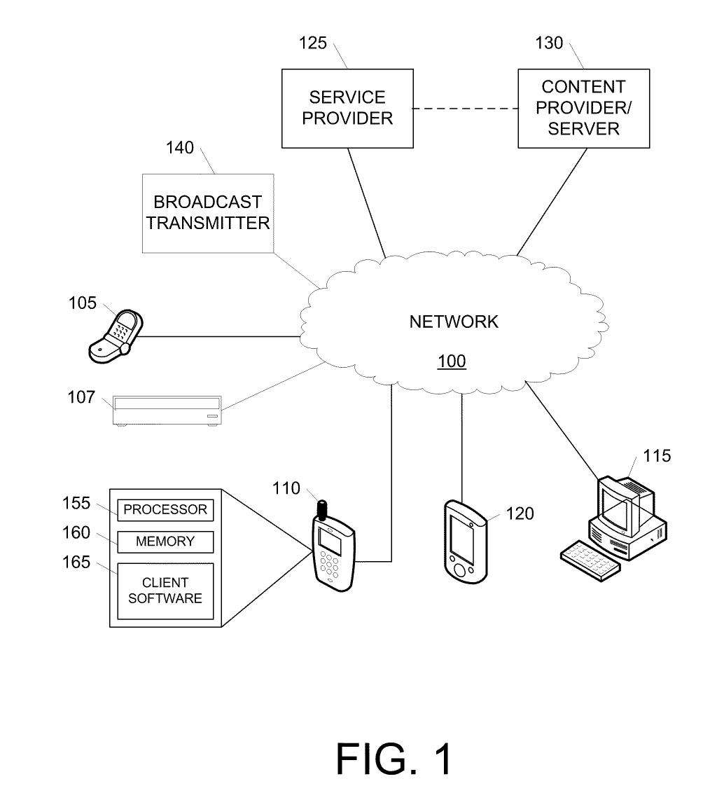

FIG. 1 illustrates an example communication network through which various inventive principles may be practiced. A number of computers and devices including mobile communication device 105, mobile phone 110, personal digital assistant (PDA) or mobile computer 120, personal computer (PC) 115, service provider 125, content provider 130, CD and/or DVD drive 107, and broadcast transmitters 140 may communicate with one another and with other devices through network 100. Network 100 may include wired and wireless connections and network elements, and connections over the network may include permanent or temporary connections. Communication through network 100 is not limited to the illustrated devices and may include additional mobile or fixed devices such as a video storage system, an audio/video player, a digital camera/camcorder, a positioning device such as a global positioning system (GPS) device or satellite, a television, an audio/video player, a radio broadcasting receiver, a set-top box (STB), a digital video recorder, remote control devices and any combination thereof. Network 100 may include a broadcast network, such as second generation terrestrial, next generation handheld, long term evolution, or other type of broadcast network.

Although shown as a single network in FIG. 1 for simplicity, network 100 may include multiple networks that are interlinked so as to provide internetworked communications. Such networks may include one or more private or public packet-switched networks, e.g. the public Internet and/or private networks utilizing Internet Protocol (IP), one or more private or public circuit-switched networks, e.g., a public switched telephone network, a cellular network configured to facilitate communications to and from mobile communication devices 105 and 110, e.g. through use of base stations, mobile switching centers, etc., a short or medium range wireless communication connection, e.g. Bluetooth®, ultra wideband (UWB), infrared, WiBree, wireless local area network (WLAN) according to one or more versions of Institute of Electrical and Electronics Engineers (IEEE) standard no. 802.11, or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 105-120 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

Devices 105-120 may be configured to interact with each other or other devices, such as content server 130 or service provider 125. In one example, mobile device 110 may include client software 165 that is configured to coordinate the transmission and reception of information to and from content provider/server 130. In one arrangement, client software 165 may include application or server specific protocols for requesting and receiving content from content server 130. For example, client software 165 may comprise a Web browser or mobile variants thereof and content provider/server 130 may comprise a web server. Billing services (not shown) may also be included to charge access or data fees for services rendered. In one arrangement where service provider 125 provides cellular network access, e.g. acts as a wireless service provider, client software 165 may include instructions for access and communication through the cellular network. Client software 165 may be stored in computer-readable memory 160 such as read only, random access memory, writeable and rewriteable media and removable media in device 110 and may include instructions that cause one or more components—e.g., processor 155, a transceiver, and a display—of device 110 to perform various functions and methods including those described herein.

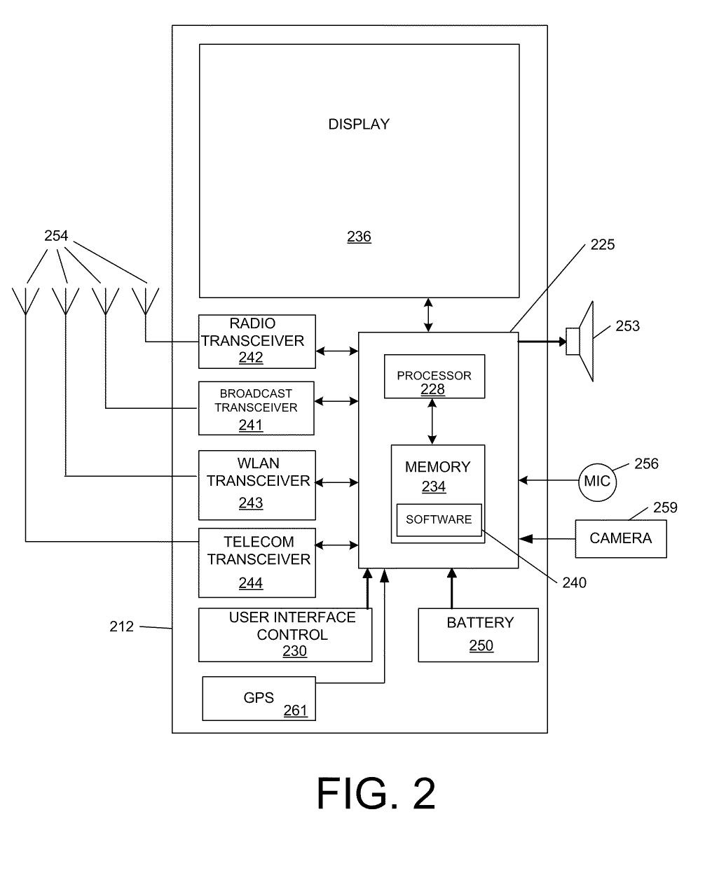

FIG. 2 illustrates an example computing device—mobile device 212—that may be used in network 100 of FIG. 1. Mobile device 212 may include a controller 225 connected to a user interface control 230, display 236 and other elements as illustrated. Controller 225 may include one or more processors 228 and one or more memories 234 storing software 240, e.g. client software 165. Mobile device 212 also may include one or more of battery 250, speaker 253 and antenna 254. User interface control 230 may include controllers or adapters configured to receive input from or provide output to a camera 259, keypad, touch screen, voice interface (e.g. via microphone 256), function keys, joystick, data glove, mouse and the like. Additionally or alternatively, camera 259 and microphone 256 may be configured to capture various types of content including video, audio and still images.

Computer executable instructions and data used by processor 228 and other components of mobile device 212 may be stored in a storage facility such as memory 234. Memory 234 may comprise any type or combination of read only memory (ROM) modules or random access memory (RAM) modules, including both volatile and nonvolatile memory such as disks. Software 240 may be stored within memory 234 to provide instructions to processor 228 such that when the instructions are executed, processor 228, mobile device 212 and/or other components of mobile device 212 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like. Some or all of the instructions implemented by processor 228 or other components so as to carry out the operations described herein may also be stored as hard-wired instructions (e.g., logic gates). For example, processor 228 could include one or more application specific integrated circuits (ASICs) configured to carry out operations such as those described herein.

Mobile device 212 or its various components may be configured to transmit and/or receive, decode and process various types of transmissions including digital broadband broadcast transmissions that are based, for example, on one or more Digital Video Broadcast (DVB) standards, such as Digital Video Broadcast-Handheld (DVB-H), Digital Video Broadcast-Terrestrial (DVB-T), Digital Video Broadcast-Second Generation Terrestrial/Next Generation Handheld (DVB-T2/NGH), Digital Video Broadcast-Cable (DVB-C), Digital Video Broadcast-Second Generation Cable (DVB-C2), Digital Video Broadcast-Satellite (DVB-S), Digital Video Broadcast-Second Generation Satellite (DVB-S2) or Digital Video Broadcast-Multimedia Home Platform (DVB-MHP), through a specific broadcast transceiver 241. Other digital transmission formats may alternatively be used to deliver content and information regarding availability of supplemental services. Additionally or alternatively, mobile device 212 may be configured to receive, decode and process transmissions through FM/AM Radio transceiver 242, wireless local area network (WLAN) transceiver 243, and telecommunications transceiver 244. Transceivers 241, 242, 243 and 244 may, alternatively, include individual transmitter and receiver components. In one or more arrangements, mobile device 212 may further include a gyroscopic sensor (not shown) configured to determine an orientation of mobile device 212. According to one or more further aspects, mobile device 212 may include a GPS device for receiving and determining location information from one or more GPS satellites.

Although the above description of FIG. 2 generally relates to a mobile device, other apparatuses or devices or systems may include the same or similar components and perform the same or similar functions and methods. For example, a stationary computer such as PC 115 (FIG. 1) may include the components or a subset of the components described above and may be configured to perform the same or similar functions as mobile device 212 and its components. Other example apparatuses that may include one or more of the components illustrated in FIG. 2 include terminal devices, televisions, displays, set-top boxes, set-top units or routers. For example, a router may be configured to receive digital broadcasts using a transceiver such as transceiver 241 and to route the data to a display device or other computing device such as PC 115 or mobile device 212, a set-top box (not shown) a television display and the like. Such apparatuses may include dedicated processors such as video encoders or decoders in a display device or general processors such as those used in general computing systems. Additional or alternative components may also be included in apparatuses configured according to aspects described herein.

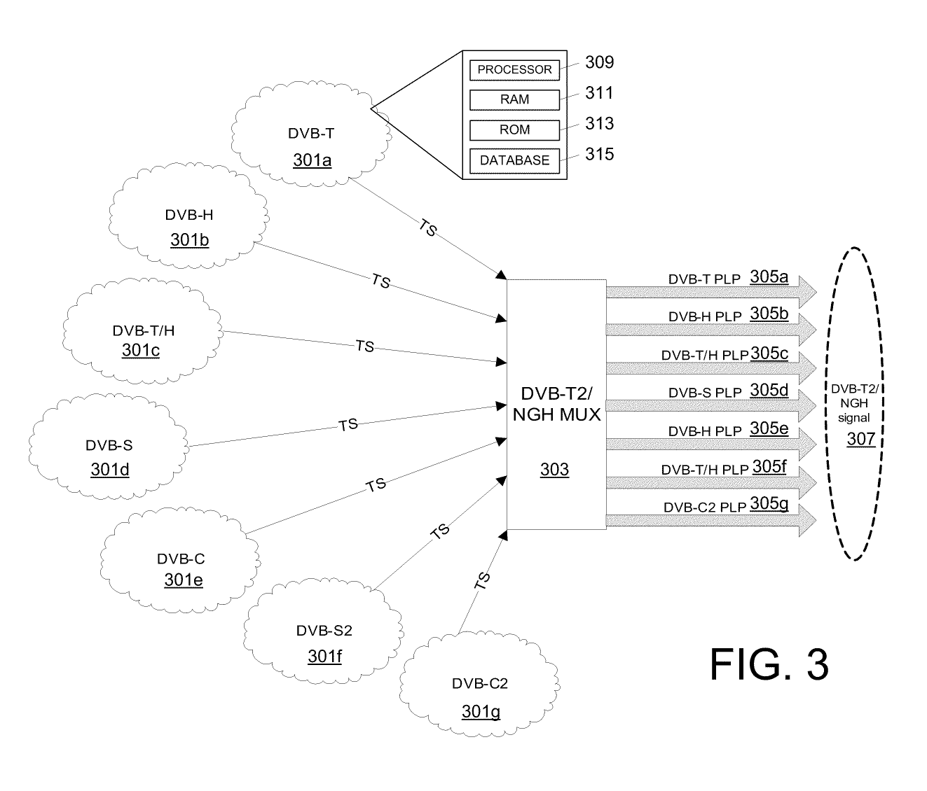

FIG. 3 illustrates an example broadcast network through which multiple types of broadcast transmissions may be tunneled through a broadcast or multiplex stream. The various broadcast transmissions may be received from a variety of content sources 301a-301g. Each of the transport streams may be inputted into a multiplexer 303 configured to multiplex streams 305a-305g into a single broadcast stream 307 formatted according to a non-receiver compatible broadcast protocol such as DVB-T2/NGH. In one or more arrangements, the broadcast stream protocol may be different from the broadcast protocols of one or more of the multiplexed/tunneled streams 305a-305g.

According to one or more aspects, each of multiplexed streams 305a-305g is carried through different physical layer pipes (PLPs) of broadcast stream 307. A PLP, as used herein, generally refers to a channel providing allocated resources through which data for particular services or content may be transmitted in the physical layer (as defined in the Open Systems Interconnection (OSI) Reference Model). Each of multiplexed streams 305a-305g may include program specific information/service information (PSI/SI) defining the services provided. For example, the PSI/SI for stream 305a might indicate a service provider (e.g., a television broadcast provider) and a service type (e.g., FM radio, digital radio, digital television) for the content included therein. Additionally or alternatively, carrier stream 307 may include PSI/SI for services that are currently available or that will be available in the future.

Content servers 301a-301g may each include various components including a processor 309, random access memory (RAM) 311, read only memory (ROM) 313 and a database 315. Processor 309 may be configured to execute various instructions and to perform calculations for preparing and transmitting scalable video broadcasts. RAM 311 and ROM 313 may be configured to store instructions for execution or access by the processor 309. Database 315 may be used to store content, subscriber information, network information and the like.

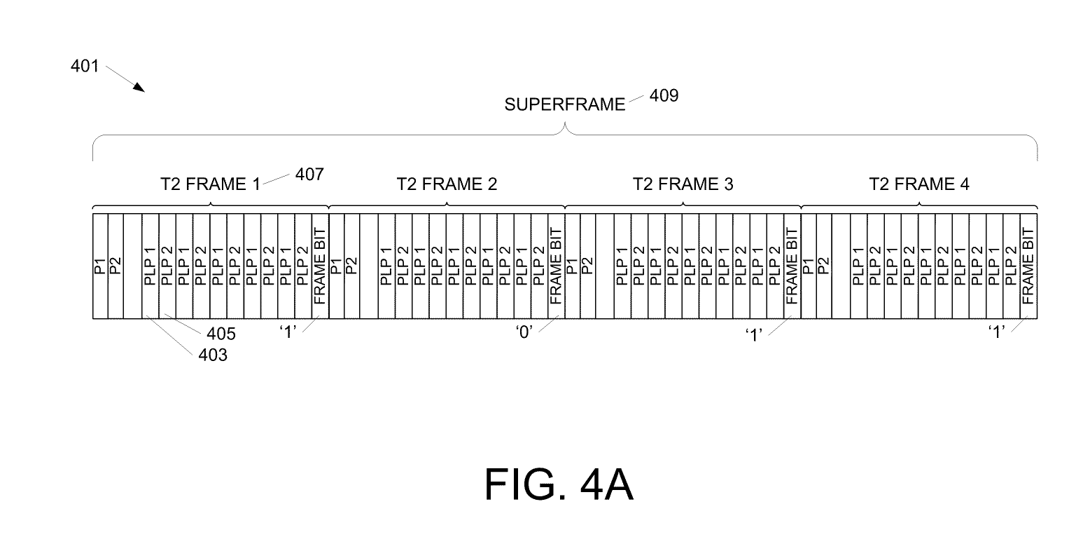

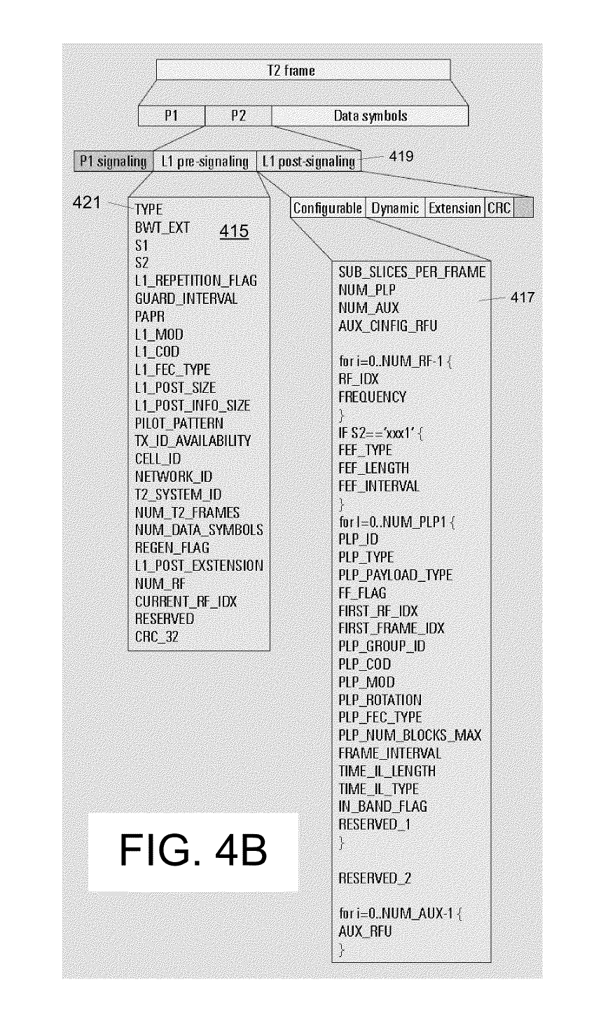

FIG. 4A illustrates a broadcast stream. In the example, the broadcast stream is an example DVB-T2 transport stream in which various services and streams may be tunneled using different PLPs. For example, PLP1 403 may be used to deliver a DVB-T transport stream while PLP2 405 may be used to carry a DVB-C transport stream. In order to identify each of the transport streams, signaling information may be provided in at least one L1 pre-signaling section of one or more frames such as frame 407 and superframe 409. A superframe denotes a series of X frames each ending in a framing bit, where X corresponds to a number of bits in a framing bit pattern formed by framing bits of X consecutive frames. The framing bit pattern is generally used to identify the end of each frame and to help a receiver align itself with the transmission. Accordingly, if a framing bit pattern is 4 bits long, a superframe comprises 4 frames.

In the illustrated example, the framing bit pattern is 1011. Thus, if the receiver knows that each frame in a transport stream is 32 bits long, the receiver will look for the bits 1, 0, 1 and 1 spaced 32 bits apart from the preceding bit and in that particular order. This allows the receiver to align itself so that it is able to time its reception of frames appropriately.

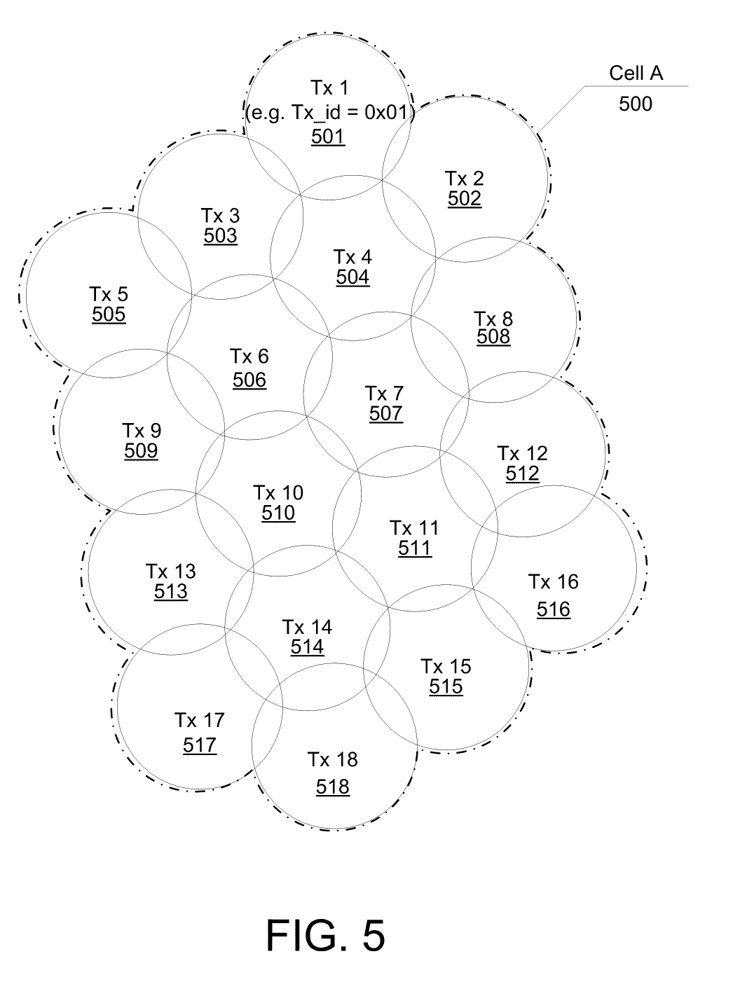

FIG. 4B illustrates a pre-signaling section and a post-signaling section of a transmission frame such as frame 407 of FIG. 4A. L1 pre-signaling carried in the P2 symbols may have a fixed size, coding and modulation, including basic information about the broadcast system as well as information needed to decode the L1-post signaling. The L1 pre-signaling may remain the same for the duration of a super-frame. L1-post signaling carried in the P2 symbol may carry more detailed L1 information about the broadcast system and the PLPs. ‘TYPE’ field 421 of L1 pre-signaling section 415 in pilot signal P2 may be defined according to the table shown in FIG. 5, where the various types of transmissions are identified according to predefined values. Values may also be assigned for any combination of stream types. For example, a value of ‘8’ may be assigned for a stream carrying both DVB-T and DVB-S content while a value of ‘9’ may correspond to a stream carrying DVB-T, DVB-S and DVB-C content.

Pilot signals P1 and P2 are generally defined to enable fast channel searching and service discovery within a frame. In particular, pilot signal P1 may be used to enable a fast initial scan for signals and to signal Fast Fourier Transform (FFT)-size and frequency offsets to a receiver while pilot signal P2 may be used to define physical layer (L1) and frame specific information in addition to data link layer (L2) signaling. For example, L2 signaling may include program specific information/service information. Accordingly, by examining L1 pre-signaling section 415 and, in particular, ‘TYPE’ field 421, a receiver may recognize the types of broadcasts that are carried within stream 401 and determine whether to process those broadcasts. In some arrangements, the P1 and P2 signaling information may be defined for an entire superframe rather than a single frame (i.e., specifying types of broadcast transmissions across an entire superframe and not just the frame in which the P1 and P2 signaling information is carried).

Additionally, a receiver may identify the particular PLPs corresponding to each of the types of broadcasts carried in stream 401 using data specified in configurable portion 417 of L1 post-signaling section 419. As illustrated in FIG. 4A, configurable portion 417 may define a series of parameters and variables for each PLP, including PLP_PAYLOAD_TYPE. This parameter, PLP_PAYLOAD_TYPE, may be used to define the type of broadcast transmission that is carried in a corresponding PLP (e.g., identified by PLP_ID).

A fringe area is a coverage area within a broadcast network, for example in a cell or within a transmitter part of one cell, where a broadcast signal from a “default” system is not available. Such fringe areas may include buildings, tunnels, and secluded areas. Any number of different reasons may exist for why such a fringe area is present, including obstructions due to high levels of concrete and/or metal, electromechanical interference, electrical interference, and/or other reasons. Fringe areas may be permanent and/or may be intermittent. For example, a building or tunnel may be a permanent type of fringe area while a construction area may be an intermittent type of fringe area. For an intermittent type of fringe area, the fringe area may cease to exist. If a broadcast signal is not available, it is desired to have access to the same service or to any service by a different transmission system. Such different transmission systems may include, e.g., 3G networks, wireless local area network, LTE networks and/or any other suitable networks.

FIG. 5 illustrates an example diagram of a cell in a broadcast network (indicated by dashed lines) with several transmitter coverage areas according to one or more aspects described herein. Each transmitter is identified with a unique identifier (e.g., Tx_id=0x01). The signaling of a transmitter identifier within a DVB-T2/NGH system may be provided, e.g., within Future Extension Frames (FEFs), within extended P1 symbols, and within L1 signaling. As shown in FIG. 5, cell A 500 includes eighteen different transmitters, 501-518. Various portions of the transmitters 501-518 overlap in coverage to ensure coverage within the entirety of the cell A 500. Cell A 500 is shown as the general broken line surrounding the various outer edges of the coverage areas of included transmitters 501-518. As described herein, coverage areas of transmitters from one cell may overlap coverage areas of transmitters from another cell.

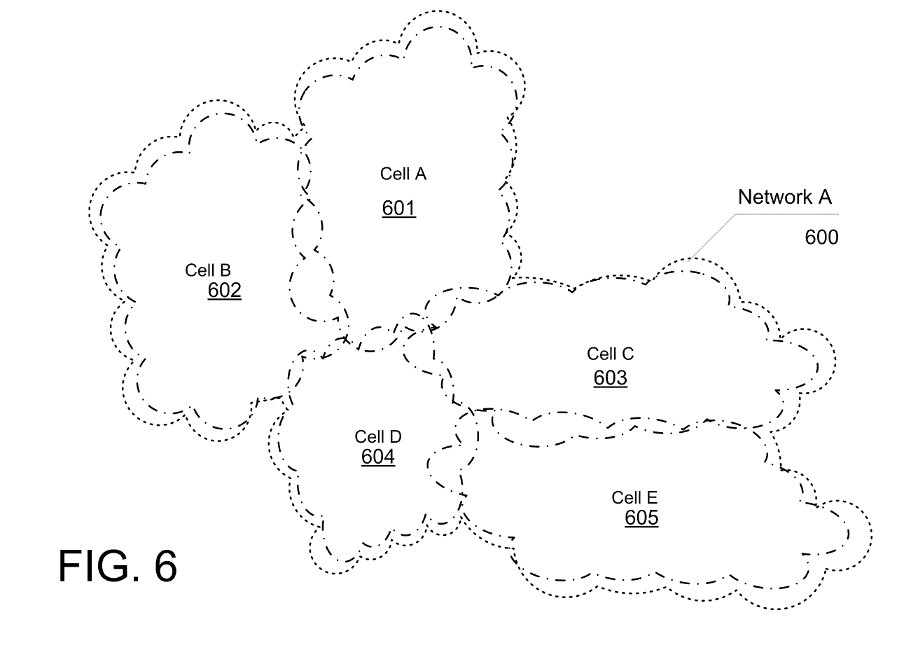

FIG. 6 illustrates an example diagram of a network A 600 with several cells according to one or more aspects described herein. As shown, network A 600 includes five different cells, cell A 601, cell B 602, cell C 603, cell D 604, and cell E 605. Similar to the transmitters in FIG. 5, various portions of the cells 601-605 overlap in coverage to ensure coverage within the entirety of the network A 600. In accordance with at least one embodiment, cell A 500 in FIG. 5 may be cell A 600 in FIG. 6. Network A 600 is shown as the general broken line surrounding the various outer edges of the coverage areas of included cells 601-605. As described herein, coverage areas of transmitters from one cell may overlap coverage areas of transmitters from another cell.

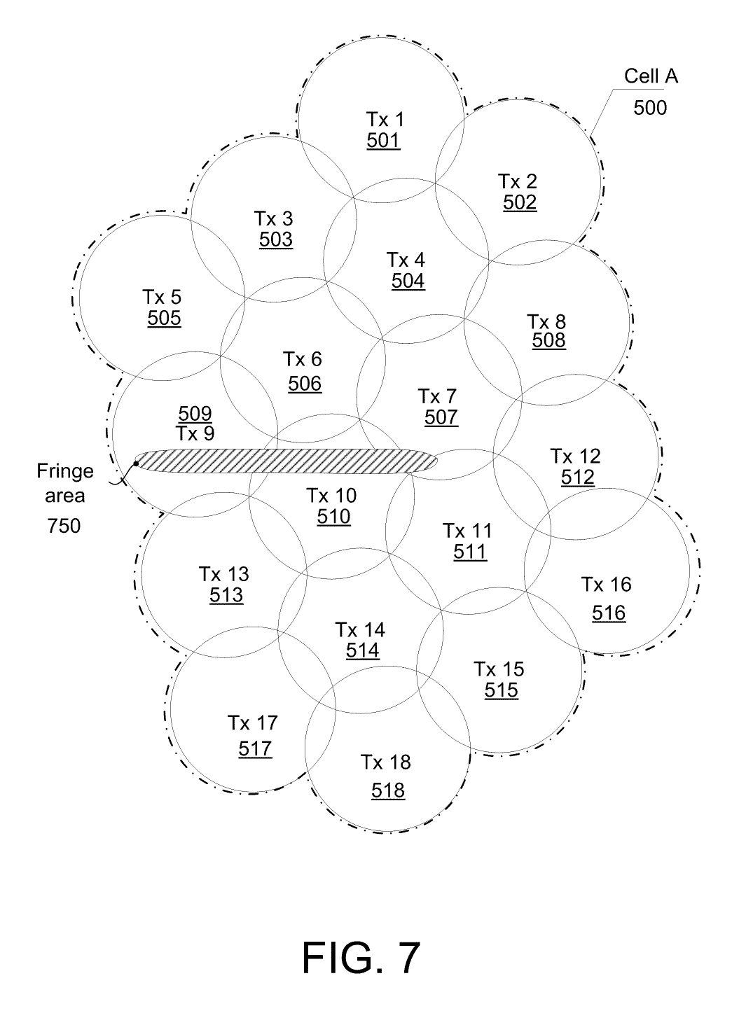

FIG. 7 illustrates the example diagram of a cell in FIG. 5 with a fringe area included according to one or more aspects described herein. A fringe area may be located within the area of one cell or it may be located over the area of several cells in a network. FIG. 7 shows an example of a fringe area 750 within a DVB-T2/NGH network, located within the area of one cell A 500 only. As shown, fringe area 750 spans the coverage areas of four transmitters, Tx7 507, Tx9 509, Tx10 510, and Tx11 511. In the example shown in FIG. 7, fringe area 750 may correlate to a tunnel in the cell. In other embodiments the several fringe are as might be available within the area of one cell.

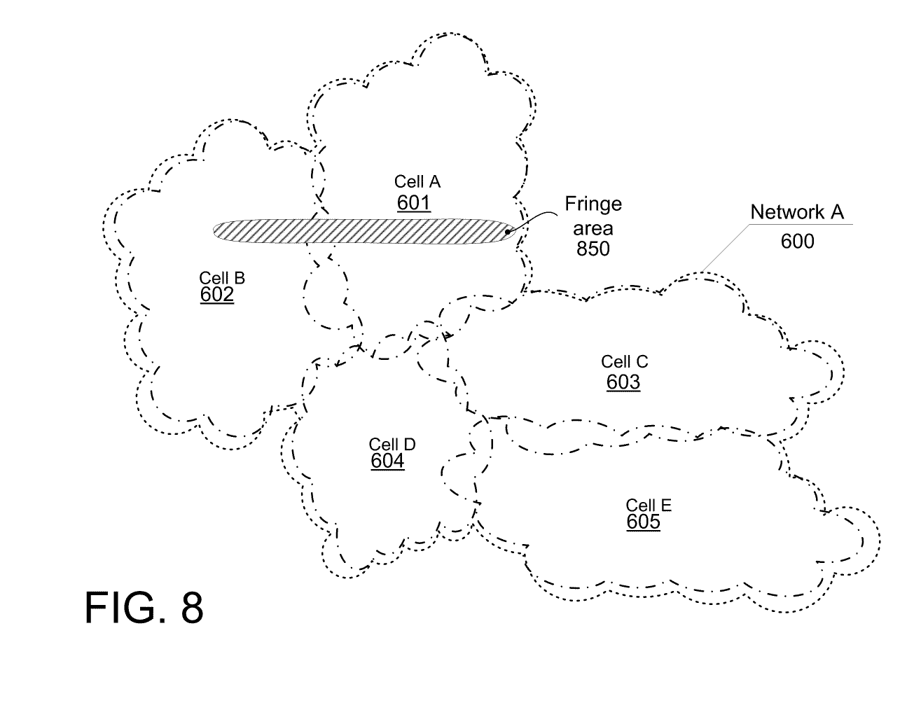

FIG. 8 illustrates the example diagram of a network in FIG. 6 with a fringe area 850 included according to one or more aspects described herein. FIG. 8 illustrates an example of a fringe area 850 where the fringe area 850 spans over two cells, cell A 601, and cell B 602.

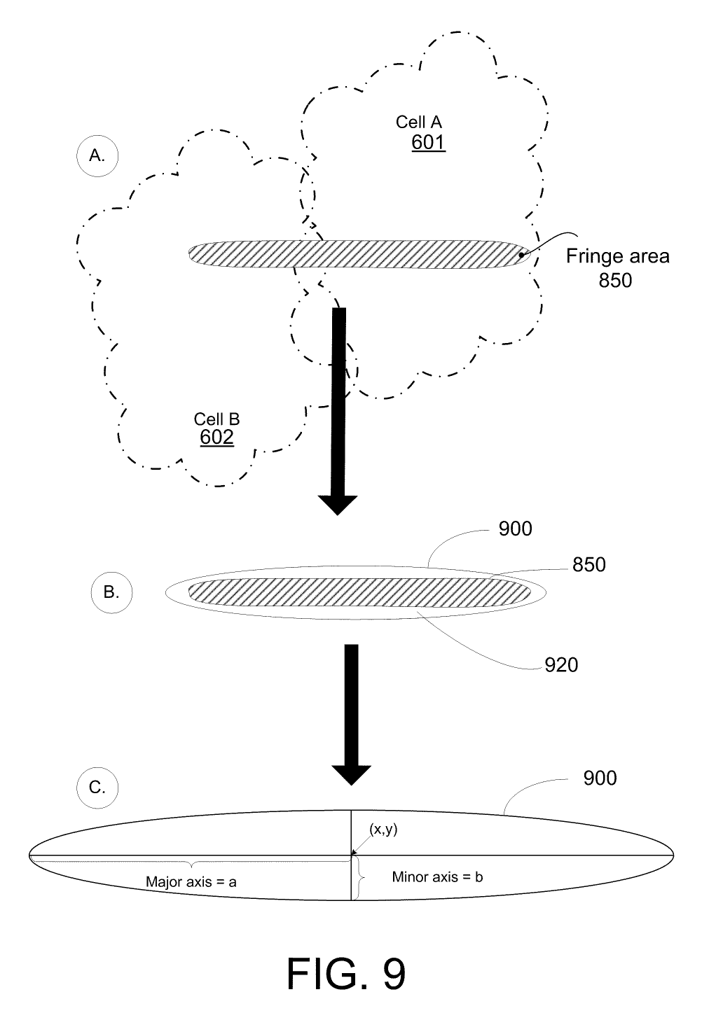

According to some exemplary embodiments, a receiver may be signaled of the existence of a fringe area. FIG. 9 illustrates a diagram of signaling of a fringe area by utilizing one type of an ellipse according to one or more aspects described herein. The following principles described herein may be utilized for signaling a fringe area in a network confined to a single cell and/or to a plurality of cells. As shown by A in FIG. 9, fringe area 850 occurs within the area of cell A 601 and cell B 602. As shown in B, an ellipse 900 may be drawn over fringe area 850, covering fully the fringe area 850 in addition to covering some area 920 which is not part of fringe area 850. In C, the center of the ellipse 900 has the following parameters:
(x,y)=the center of the ellipse 900
a=the major axis
b=the minor axis

The formula of the ellipse 900 is as follows,

$$\frac{{( x - {x}_{0} )}^{2}}{{a}^{2}} + \frac{{( y - {y}_{0} )}^{2}}{{b}^{2}} = 1 ,$$

where a, b ε [symbol] (the set of all real numbers).

The geographical coordinates, i.e., longitude and latitude, may be given to the center of the ellipse. The ellipse may be rotated to any angle, i.e., 0-360°. Other generally elliptical shaped areas may be utilized in accordance with principles described herein. The mathematical description with respect to FIG. 9 is one example. In addition, other shaped areas beyond generally elliptical shaped areas may be utilized in accordance with one or more aspects described herein. The fringe areas do not have signal coverage and are refined with the given/used shape roughly inside the area of the given/used shape.

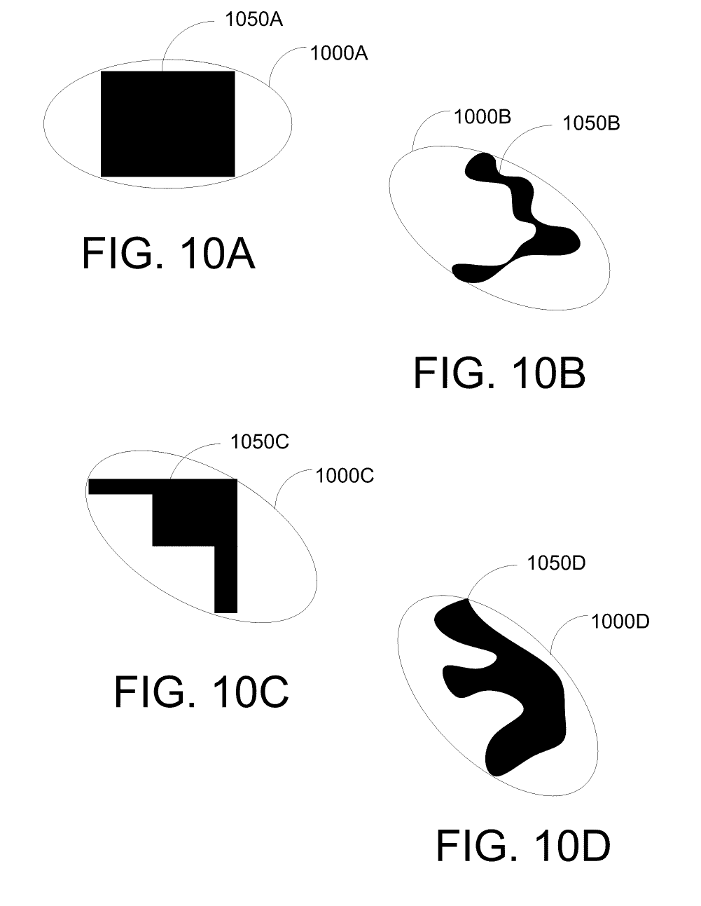

FIGS. 10A-10D illustrate examples of different shaped fringe areas. The fringe areas may be indicated by an ellipse according to one or more aspects described herein. The illustrative examples thus far have shown an oval or slightly elliptical shaped fringe area. In accordance with the present disclosure, aspects may be utilized with respect to any of a number of various shaped fringe areas within a network, a single cell, across multiple cells of a network, transmitter coverage area and/or multiple transmitter coverage areas. FIG. 10A shows an ellipse 1000A drawn over a relatively rectangular shaped fringe area 1050A. Such a fringe area may be a building. FIGS. 10B, 10C, and 10D show respective ellipses 1000B, 1000C, and 1000D drawn over different shaped respective fringe areas 1050B, 1050C, and 1050D.

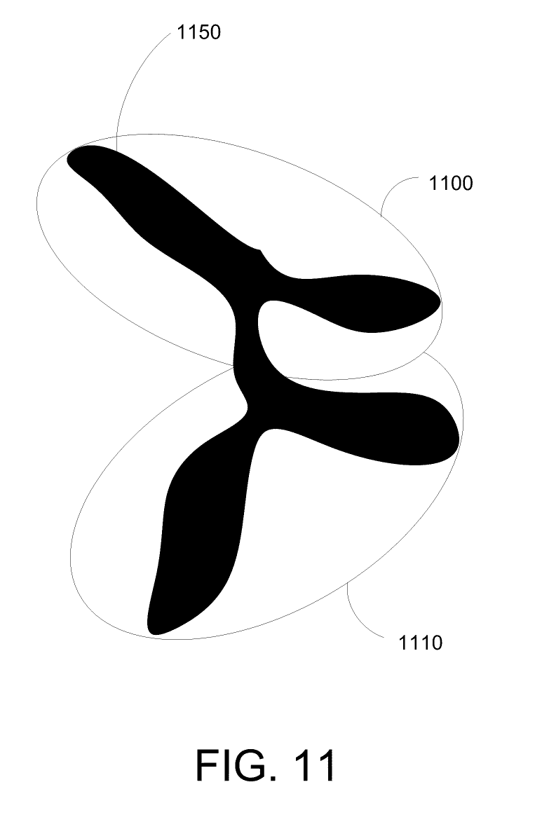

Due to the odd shape of a fringe area, utilizing a single ellipse to be drawn over the entire fringe area may not be desired. Utilizing a single ellipse in some odd shaped fringe areas may have more area outside of the fringe area itself included within the ellipse than the actual fringe area. In accordance with at least one aspect of the present disclosure, a plurality of ellipses may be utilized with respect to a fringe area. FIG. 11 illustrates an example of a fringe area 1150 indicated by a plurality of ellipses 1100 and 1110 according to one or more aspects described herein. Although only shown as two ellipses, more than two may be utilized in accordance with aspects described herein.

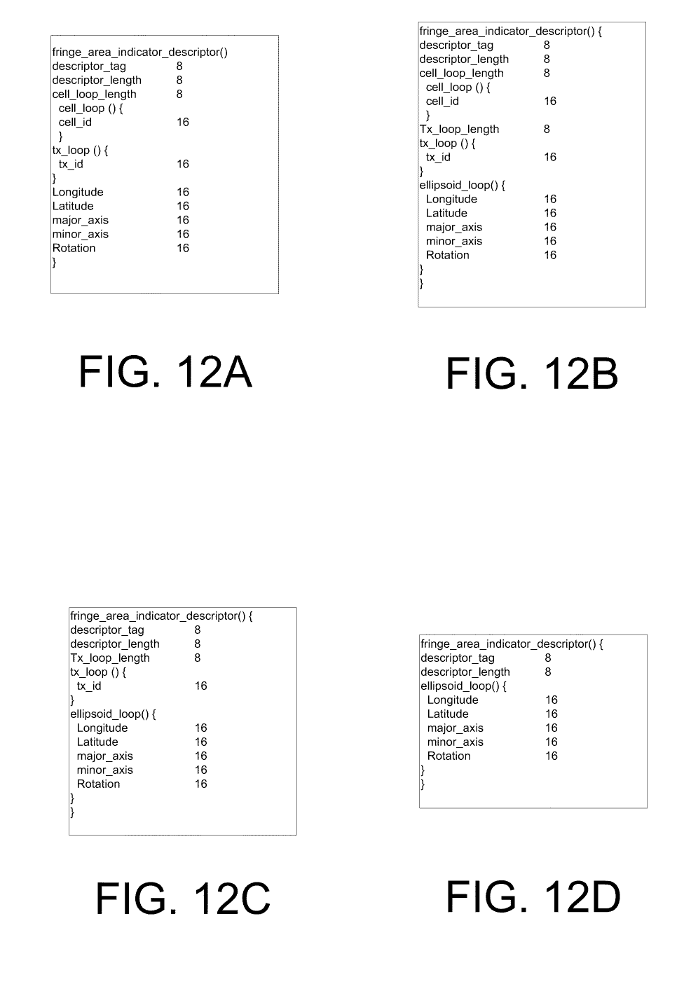

The signaling of a fringe area based on the described ellipse method may be accomplished by different combinations of the association of a fringe area with a cell, e.g., cell_id, and a transmitter identifier, e.g., Tx_id. FIGS. 12A-12D illustrate examples of a fringe area signaling structure according to one or more aspects described herein. FIGS. 12A-12D illustrate different embodiments for such signaling for the signaling structure examples of fringe area based on the example in FIG. 7. FIG. 12A illustrates an example of a fringe area signaling, where one ellipsoid is mapped with one Tx_id within one iteration of the loop. Next, FIG. 12B illustrates an example of a fringe area signaling where multiple ellipsoids may be associated with a single Tx_id within an iteration of the loop. FIG. 12C provides another example of the mapping of a fringe area information similar to that provided in FIG. 12A, except that a cell_id is not included. Finally, FIG. 12D depicts an example where only ellipsoid parameters are signaled to indicate a fringe area. The parameters (longitude, latitude, major_axis, minor_axis and rotation) defined in FIGS. 12A-12D refer to the equation:

((x−xo)²/a²)+((y−y0)²/b²)=1

In mathematics, an ellipse may be defined in origo (x0=0 and y0=0) and so that half axises are parallel to x and y axis. Due to this definition, a rotation is utilized which determines how much the ellipse or coordinate is turned compared to “normal” coordinates.

The syntax and semantics for parameters within the fringe_area_descriptor may be described in the following:
tx_id: This 16-bit field identifies a transmitter within the cell.
cell_id: This 16-bit field identifies a cell within the network.
Tx_loop_length: This 8-bit field indicates the length of the tx_loop counted in Bytes. It provides the information of how many tx_ids are announced within the table.
cell_loop_length: This 8-bit field indicates the length in Bytes of the loop for cell_id and tx_id announcement. It provides the information of how many cells and/or tx_ids are announced within the table.
Longitude: This 16-bit field indicates the x-coordinate for the centerpoint of ellipse (x0) covering the fringe area.
Latitude: This 16-bit field indicates the x-coordinate for the centerpoint of ellipse (y0) covering the fringe area.
major_axis: This 16-bit field indicates the length of the major axis of the ellipsoid covering the fringe area.
minor_axis: This 16-bit field indicates the length of the minor axis of the ellipsoid covering the fringe area.
rotation: This 16-bit field indicates the rotation angle of ellipse in degrees ranging between 0° and 360°.

Other representations of signaling may be used to specify a generally elliptical shape.

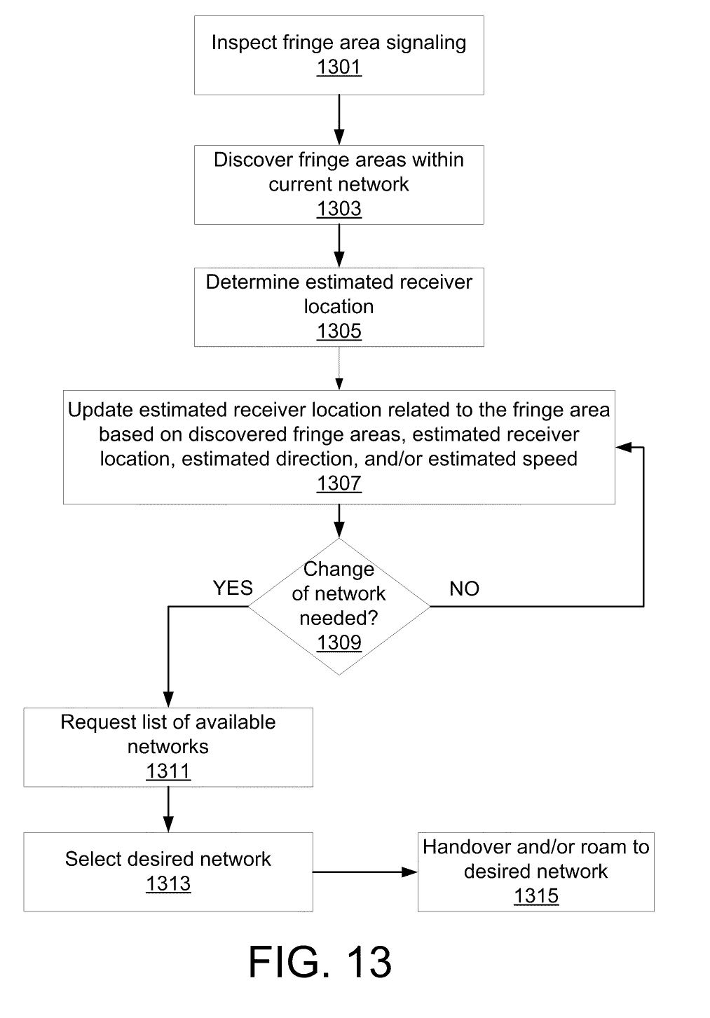

FIG. 13 is a flowchart illustrating an exemplary method for fringe area handover performed by a mobile receiving device according to one or more aspects described herein. In step 1301, the signaling indicating the location of a fringe area within a network and related cells and/or Tx_ids is inspected. In accordance with one example, the location may be inspected from the fringe_area_indicator_descriptor. In step 1303, fringe areas within the current network may be discovered. In one example, one or more fringe areas within the current network of the mobile receiving device, such as a terminal device like a mobile phone, may be determined based upon receipt of ellipses parameter information in at least one signaling section of the broadcast stream. As described herein with respect to FIGS. 9-12D, fringe areas within a broadcast network of a mobile receiving device may be identified as elliptical related data in one or more signaling sections of the broadcast stream. In an illustrative embodiment, this may be in the L2 signaling section, the L1 pre-signaling section, and/or the L1 post signaling section of the broadcast stream received by the mobile receiving device. Various different manners for identifying the fringe areas to the mobile receiving device may be utilized.

Proceeding to step 1305, the current estimated location of a receiver is detected in accordance with known methods, e.g., using GPS, and/or determining the location based on the received Tx_ids and cell_ids. In step 1307, the estimated location of the receiver related to the location of the indicated fringe area is determined. This determination may be done based on the information determined in step 1303, step 1305, the estimated direction of the receiver apparatus, and/or the estimated speed of the receiving apparatus.

Moving to step 1309, a determination is made as to whether a change of network is needed or should be desired. For example, this determination may be made due to the updated location information of the receiver indicating a likelihood of entering the fringe area within a predetermined period of time. If no change of network is needed, the process returns to step 1307. If the fringe area is approaching and the network change is needed to continue and/or to select alternative service for consumption, the method moves to step 1311. In step 1311, a list of potential available systems or communication networks providing such content is requested from the network. In step 1313, a desired network is selected from the list of potential available systems. Finally, the receiver performs roaming/handover into the selected network in step 1315. The handover may be performed without assistance from a transmitting, e.g., broadcast, network. In some embodiments it may be performed using two-way handoff protocols. Aspects of the method performed in FIG. 13 may be implemented by one or more processors within an apparatus or a part of an apparatus like a mobile receiving device that is configured to receive at least one broadcast stream from a broadcast network.

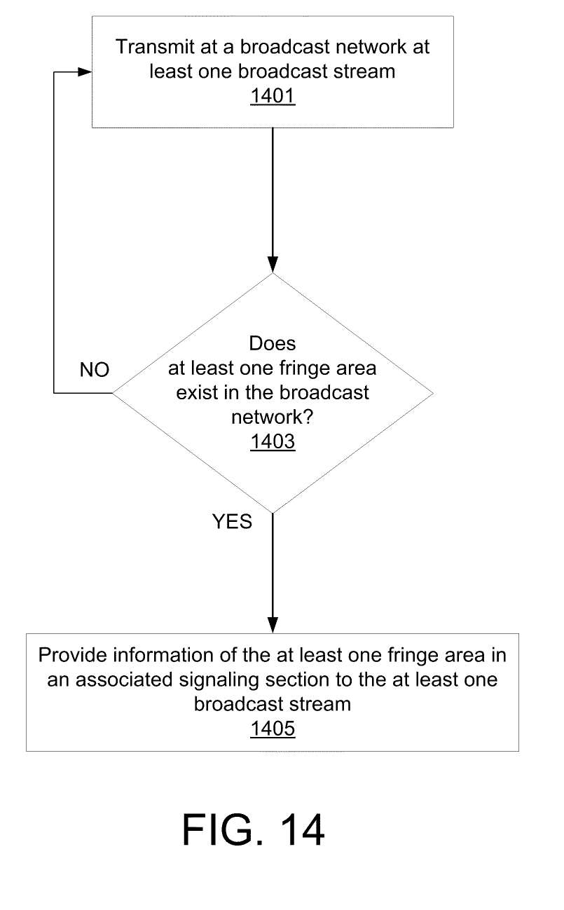

FIG. 14 is a flowchart illustrating an exemplary method for fringe area broadcast according to one or more aspects described herein. Aspects of the method performed in FIG. 14 may be implemented by one or more processors within a broadcast network that are configured to transmit a broadcast stream to at least one apparatus, for example, a mobile receiving device.

The process begins and at step 1401 at least one broadcast stream may be transmitted at a broadcast network. An example of a broadcast network may be a DVB-T2/NGH network. At step 1403, a determination is made as to whether at least one fringe area exists in the broadcast network. The at least one fringe area may be determined, for example, by means of measurement campaigns, where the signal quality information is measured, e.g., manually, within the assumed cell/transmitter coverage area and the signal coverage map is provided where the at least one fringe area may be roughly detected from the assumed cell/transmitter coverage area. This may be done during the installation phase of the network or during special tests measurements. In another aspect the receiving apparatus may act also as a tracking device where the receiving apparatus is tracking the availability of coverage and it reports it on demand or on voluntary basis to a provider. Such a determination in step 1403 may include utilizing at least one generally elliptically shaped area to indicate a location of the at least one fringe area. A generally elliptically shaped area may include information regarding a rotational angle of the shaped area for an indication of the orientation of the at least one fringe area. For example, if the fringe area is a building, the orientation of the generally elliptically shaped area may be more vertical in comparison to a fringe area correlating to a tunnel. In addition, such a determination may include utilizing a plurality of shaped areas for defining the at least one fringe area. Proceeding to step 1405, information of the at least one fringe area may be provided in at least one associated signaling section to the at least one broadcast stream. The associated signaling section may be in the L2 signaling, the L1 pre-signaling, and/or the L1 post signaling. In one example, the provided information in step 1405 may include a location of the at least one fringe area within the at least one broadcast network.

The indication of one or more fringe areas in a current cell by a transmitter via a broadcast signal to at least one receiver is described. Such information may be used to approve the handover and to enable a constant good quality of service by executing a seamless handover in advance, e.g., before fringe area is nearby, the fringe area is reached, the signal is below a threshold, and/or a signal loss occurs. One example may be a notification about a tunnel within a service area. The signaling may be done in L2 signaling, L1 pre-signaling, and/or L1 post signaling. Then, based on GPS data of the receiver or based on the information received in broadcast stream like for example cell ID or transmitter ID, handover to a network that provides the desired service like for example a 3G, WLAN or LTE network may be implemented prior to the receiver entering the fringe area.

It should be understood that any of the method steps, procedures or functions described herein may be implemented using one or more processors in combination with executable instructions stored in memory that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, digital signal processors (DSPs), field-programmable gate arrays (FPGAs), controllers, application-specific integrated circuits (ASICs), combinations of hardware/firmware/software, or other special or general-purpose processing circuitry.

The methods and features recited herein may further be implemented through any number of computer readable media that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

Additionally or alternatively, in at least some embodiments, the methods and features recited herein may be implemented through one or more integrated circuits (ICs). An integrated circuit may, for example, be a microprocessor that accesses programming instructions or other data stored in a read only memory (ROM). In some such embodiments, the ROM stores programming instructions that cause the IC to perform operations according to one or more of the methods described herein. In at least some other embodiments, one or more the methods described herein are hardwired into an IC. In other words, the IC is in such cases an application specific integrated circuit (ASIC) having gates and other logic dedicated to the calculations and other operations described herein. In still other embodiments, the IC may perform some operations based on execution of programming instructions read from ROM or RAM, with other operations hardwired into gates and other logic of IC. Further, the IC may output image data to a display buffer.

Although specific examples of carrying out the subject matter have been described, those skilled in the art will appreciate that there are numerous variations and permutations of the above-described systems and methods that are contained within the spirit and scope of the invention as set forth in the appended claims. Additionally, numerous other embodiments, modifications and variations within the scope and spirit of the appended claims will occur to persons of ordinary skill in the art from a review of this disclosure.

1. A method comprising:
transmitting at a broadcast network at least one broadcast stream;
determining if at least one fringe area exists in the broadcast network; and
providing information of the at least one fringe area in at least one signaling section associated to the at least one broadcast stream.

2. The method according to claim 1, wherein the at least one fringe area in the broadcast network is identified for at least one of: at least one cell and at least one transmitter coverage area.

3. The method according to claim 1, wherein the determining includes utilizing at least one generally elliptically shaped area to indicate a location of the at least one fringe area.

4. The method according to claim 5, wherein the at least one generally elliptically shaped area comprises an ellipse defined by:
$$\frac{{( x - {x}_{0} )}^{2}}{{a}^{2}} + \frac{{( y - {y}_{0} )}^{2}}{{b}^{2}} = 1 ,$$
where a, b ε [symbol] ,
wherein (x,y) is the center of the at least one ellipse, a is the major axis of the ellipse, b is the minor axis of the ellipse, and [symbol] is the set of all real numbers.

5. The method according to claim 3, wherein the at least one generally elliptically shaped area is defined by a rotational angle.

6. A method comprising:
receiving at least one broadcast stream;
determining information of at least one fringe area in a broadcast network associated with the at least one broadcast stream;
determining whether to change to a different communication network based upon the determined information; and
changing to the different communication network based upon the determined information.

7. The method according to claim 6, wherein the at least one fringe area in the broadcast network is identified for at least one of: at least one cell and at least one transmitter coverage area.

8. The method according to claim 6, wherein the determining information of at least one fringe area includes inspecting at least one associated signaling section of the at least one broadcast stream.

9. The method according to claim 6, wherein the information of the at least one fringe area includes data associated with at least one generally elliptically shaped area surrounding the at least one fringe area.

10. The method according to claim 6, wherein the at least one fringe area spans a plurality of transmitter coverage areas within the broadcast network.

11. An apparatus comprising:
at least one processor; and
at least one memory including computer-readable instructions that, when executed by the at least one processor, perform a method of:
transmitting at a broadcast network at least one broadcast stream;
determining if at least one fringe area exists in the broadcast network; and
providing information of the at least one fringe area in at least one signaling section associated to the at least one broadcast stream.

12. The apparatus according to claim 11, wherein the at least one fringe area in the broadcast network is identified for at least one of: at least one cell and at least one transmitter coverage area.

13. The apparatus according to claim 11, wherein the at least one processor is configured to utilize at least one generally elliptically shaped area to indicate a location of the at least one fringe area.

14. The apparatus according to claim 13, wherein the at least one generally elliptically shaped area comprises an ellipse defined by:
$$\frac{{( x - {x}_{0} )}^{2}}{{a}^{2}} + \frac{{( y - {y}_{0} )}^{2}}{{b}^{2}} = 1 ,$$
where a, b ε [symbol] ,
wherein (x,y) is the center of the at least one ellipse, a is the major axis of the ellipse, b is the minor axis of the ellipse, and R is the set of all real numbers.

15. An apparatus comprising:
at least one processor; and
at least one memory including computer-readable instructions that, when executed by the at least one processor, perform a method of:
receiving at least one broadcast stream;
determining information of at least one fringe area in a broadcast network associated with the at least one broadcast stream;
determining whether to change to a different communication network based upon the determined information; and
changing to the different communication network based upon the determined information.

16. The apparatus according to claim 15, wherein the at least one fringe area in the broadcast network is identified for at least one of: at least one cell and at least one transmitter coverage area.

17. The apparatus according to claim 15, wherein the at least one fringe area spans a plurality of cells within the broadcast network.

18. One or more computer readable media storing computer executable instructions, that when executed by at least one processor, cause the at least one processor to perform a method of:
transmitting at a broadcast network at least one broadcast stream;
determining if at least one fringe area exists in the broadcast network; and
providing information of the at least one fringe area in at least one signaling section associated to the at least one broadcast stream.

19. The one or more computer readable media according to claim 18, wherein the determining includes utilizing at least one generally elliptically shaped area to indicate a location of the at least one fringe area.

20. One or more computer readable media storing computer executable instructions, that when executed by at least one processor, cause the at least one processor to perform a method of:
receiving at least one broadcast stream;
determining information of at least one fringe area in a broadcast network associated with the at least one broadcast stream;
determining whether to change to a different communication network based upon the determined information; and
changing to the different communication network based upon the determined information.

21. The one or more computer readable media according to claim 20, wherein the determining information of at least one fringe area includes inspecting at least one associated signaling section of the at least one broadcast stream.
